(19) United States
(12) Patent Application Publication
(10) Pub. No.: US 2024/0331133 A1
(43) Pub. Date: Oct. 3, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: MASAHARU SATO, Kanagawa (JP)

(21) Appl. No.: 18/604,629

(22) Filed: Mar. 14, 2024

(30) Foreign Application Priority Data
Mar. 27, 2023 (JP) 2023-049700

(51) Int. Cl. G06T 7/00; G06V 10/24; G06V 10/60

(52) U.S. Cl. CPC G06T 7/001; G06V 10/24; G06V 10/60; G06T 2207/30144

(57) ABSTRACT

A usage ratio calculation unit calculates a reference transparency, and generates a reference reflected light usage ratio map and a reference transmitted light usage ratio map by using the calculated reference transparency. A weighted reference reflected light image and a weighted inspection reflected light image obtained by applying the reference reflected light usage ratio map to a reference reflected light image and an inspection reflected light image are generated. Similarly, a weighted reference transmitted light image and a weighted inspection transmitted light image obtained by applying the reference transmitted light usage ratio map to a reference transmitted light image and an inspection transmitted light image are generated. An inspection processing unit inspects a printed material based on a difference between the weighted reference reflected light image and the weighted inspection reflected light image and a difference between the weighted reference transmitted light image and the weighted inspection transmitted light image.

### BACKGROUND

### Cross Reference to Priority Application

This application claims the benefit of Japanese Patent Application No. 2023-049700 filed Mar. 27, 2023, which is hereby incorporated by reference herein in its entirety.

### FIELD

The present invention relates to an image processing technology of inspecting a printed material outputted by a printing apparatus.

### DESCRIPTION OF THE RELATED ART

In printing business, work of inspecting a printing material for a defect is performed to guarantee that the printed material has no defect and has problem-free quality. In an inspection method of the printed material, inspection is performed by using a difference between two types of image data: image data to be a reference of quality (hereinafter, referred to as reference image); and image data of an inspection target (hereinafter, referred to as inspection image) that is obtained by capturing an image of the printed material with a sensor or the like.

A non-transparent sheet with low light transmittance such as copying paper and a transparent sheet with high light transmittance such as a transparent film for product protection and a transparent label for wrapping are used in many cases as sheets used in printing. In the case where inspection is performed on the printed material using the non-transparent sheet, an imaging method of receiving reflected light from the printed material is used. Meanwhile, in the case where inspection is performed on the printed material using the transparent sheet, an imaging method of receiving not only the reflected light but also transmitted light is used. This is due to the following reason. In the case where an image of the printed material using the transparent sheet is captured with the printed material placed on a black plate, absorption of light due to a color material and transmittance of light in a transparent portion cannot be distinguished from each other in a captured image obtained based on only the reflected light. Since the light transmitted through the transparent portion is absorbed by the black plate and a proportion of the light that is reflected is low, an image of the transparent portion seemingly becomes an image of a portion where a “solid” pattern with high color material density is printed. Accordingly, the imaging method of receiving not only the reflected light but also the transmitted light is used for the printed material using the transparent sheet. International Patent Application Publication No. 2020/158725 discloses a method of inspecting a printed material using a transparent sheet based on captured images obtained by performing image capturing while using transmitted light and reflected light. Illumination conditions such as proportions of a transmitted light intensity and a reflected light intensity are determined depending on inspection contents.

However, in the method of International Patent Application Publication No. 2020/158725, in the case where defects are present in both of a transparent portion and a non-transparent portion of the printed material printed on the transparent sheet and the inspection is performed based on an image obtained by performing image capturing with irradiation of only one of the reflected light and the transmitted light, one of the defects cannot be correctly detected. Meanwhile, in the case where the inspection is performed based on an image obtained by performing image capturing with simultaneous irradiation of both of the reflected light and the transmitted light, both defects can be detected, but detection accuracy decreases for both defects.

Accordingly, an object of the present invention is to detect a defect in a printed material using a transparent sheet with high accuracy.

### SUMMARY

An image processing apparatus according to the present invention includes: a first obtaining unit configured to obtain a first inspection target image obtained by receiving reflected light from a printed material and a second inspection target image obtained by receiving transmitted light from the printed material; a second obtaining unit configured to obtain a first reference image corresponding to the first inspection target image and a second reference image corresponding to the second inspection target image; and an inspection unit configured to perform at least one of first inspection using the first reference image and the first inspection target image and second inspection using the second reference image and the second inspection target image for each of regions in the printed material.

Further features of the present disclosure will become apparent from the following description of exemplary embodiments with reference to the attached drawings.

### BRIEF DESCRIPTION OF THE DRAWINGS

FIG. 1A is a conceptual diagram for explaining characteristics of reflected light;

FIG. 1B is a conceptual diagram for explaining the characteristics of the reflected light;

FIG. 1C is a conceptual diagram for explaining the characteristics of the reflected light;

FIG. 2A is a conceptual diagram for explaining characteristics of transmitted light;

FIG. 2B is a conceptual diagram for explaining the characteristics of the transmitted light;

FIG. 2C is a conceptual diagram for explaining the characteristics of the transmitted light;

FIG. 3A is light receiving characteristics of a diffuse-reflected light intensity and a directional transmitted light intensity in a transparent sheet;

FIG. 3B is the light receiving characteristics of the diffuse-reflected light intensity and the directional transmitted light intensity in the transparent sheet;

FIG. 3C is the light receiving characteristics of the diffuse-reflected light intensity and the directional transmitted light intensity in the transparent sheet;

FIG. 4 is a configuration diagram of an entire printing system including an image processing unit in Embodiment 1;

FIG. 5 is a block diagram illustrating a configuration example of the image processing unit in Embodiment 1;

FIG. 6A is a diagram illustrating a configuration example of an image reading device in Embodiment 1;

FIG. 6B is a diagram illustrating the configuration example of the image reading device in Embodiment 1;

FIG. 7 is a main processing flow illustrating inspection processing including inspection processing executed by the image processing unit in Embodiment 1;

FIG. 8 is a processing flow for generating a reference transmitted light usage ratio map and a reference reflected light usage ratio map in Embodiment 1;

FIG. 9 is a processing flow for generating an inspection transmitted light usage ratio map and an inspection reflected light usage ratio map in Embodiment 1;

FIG. 10 is a processing flow for calculating a transparency in Modified Example 1 of Embodiment 1;

FIG. 11 is a processing flow for calculating a transparency in Modified Example 2 of Embodiment 1;

FIG. 12 is a block diagram illustrating a configuration example of the image processing unit in Modified Example 3 of Embodiment 1;

FIG. 13 is a main processing flow illustrating inspection processing including inspection processing executed by the image processing unit in Embodiment 2;

FIG. 14 is a processing flow for generating an inspection image in Embodiment 2;

FIG. 15 is a block diagram illustrating a configuration example of the image processing unit in Embodiment 3;

FIG. 16 is a main processing flow illustrating inspection processing including inspection processing executed by the image processing unit in Embodiment 3;

FIG. 17 is a processing flow for performing alignment on reference images in Embodiment 3; and

FIG. 18 is a processing flow for performing alignment on inspection images in Embodiment 3.

### DESCRIPTION OF THE EMBODIMENTS

Embodiments of the present invention are described below with reference to the drawings. The following embodiments do not limit the present invention, and not all of the combinations of the features described in the present embodiment are necessarily essential for the solving means of the present invention. Note that the identical configurations are explained by being denoted by the same reference numerals.

### Embodiment 1

In the present embodiment, explanation is given of an inspection method in which a transparency of a transparent sheet is calculated from a directional transmitted light intensity image that is transmitted light information of the transparent sheet and a usage ratio between the transmitted light information and reflected light information is changed for each region.

### <Explanation of Reflected Light and Transmitted Light>

First, differences of obtained transmitted light and reflected light depending on whether a printed material is a transparent sheet or a non-transparent sheet are explained.

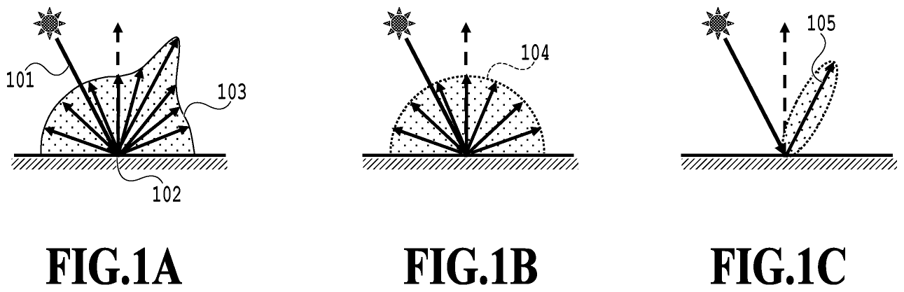

FIG. 1A is a schematic diagram for explaining a reflection characteristic at a certain position on an object surface. FIG. 1A illustrates distribution 103 of reflected light in the case where light is emitted in a direction from a light source 101 toward a point of incidence 102 on the object surface. This reflected light is superimposing of a diffuse-reflected light component illustrated in FIG. 1B and a specular reflected light component illustrated in FIG. 1C. The diffuse-reflected light component is generated by diffused reflection of the incident light in an object surface layer, and is observed at an equal intensity at equidistant positions from the point of incidence. This intensity is referred to as diffuse-reflected light intensity 104. Meanwhile, the specular reflected light component is generated in the case where the incident light is reflected on the object surface in a specular reflection direction. The specular reflection direction is a direction in a plane (plane of incidence) including an incident ray and a normal of the object surface at the point of incidence, and is a direction in which an angle formed between the specular reflection direction and the normal at the point of incidence is equal to an angle formed between the incident ray and the normal at the point of incidence. The maximum intensity in the specular reflected light component is referred to as specular reflected light intensity 105. The specular reflected light intensity 105 is high in the case where the object surface is smooth.

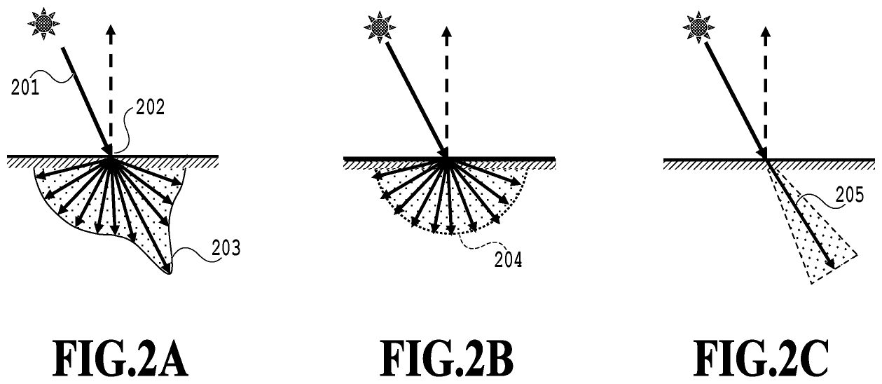

FIG. 2A is a schematic diagram for explaining a transmission characteristic at a certain position on an object surface. FIG. 2A illustrates distribution 203 of transmitted light in the case where light is emitted in a direction from a light source 201 toward a point of incidence 202 on the object surface. The light transmitted through the object surface is superimposing of a diffuse-transmitted light component (non-directional transmitted light component) illustrated in FIG. 2B and a directional transmitted light component illustrated in FIG. 2C. The diffuse-transmitted light component is generated by scattering of the incident light in a spherical shape caused by unevenness on a surface or in an interior of the object in the case the incident light exits the object on the opposite side, and is observed at an equal intensity at equidistant positions from the point of incidence. This intensity is referred to as diffuse-transmitted light intensity 204. Meanwhile, the directional transmitted light component is generated by the incident light traveling inside the object in a straight line and exiting the object on the opposite side. A transmittance intensity in a direction in which a directional transmitted light intensity is the highest is referred to as directional transmitted light intensity 205.

A target in the present disclosure is a printed material that uses a general color material by which an uneven surface is obtained, instead of a special color material by which a smooth surface is obtained. Accordingly, the reflected light intensity detected in the case where the printed material is read is assumed to be diffuse-reflected light intensity 104. Moreover, the transparent sheet used as a print medium is a medium in which a property of allowing the incident light to travel in a straight line is high and the diffuse-transmitted light intensity 204 is less likely to be detected. Accordingly, the transmitted light intensity detected in the case where the printed material is read is assumed to be the directional transmitted light intensity 205.

### <Focused Characteristics>

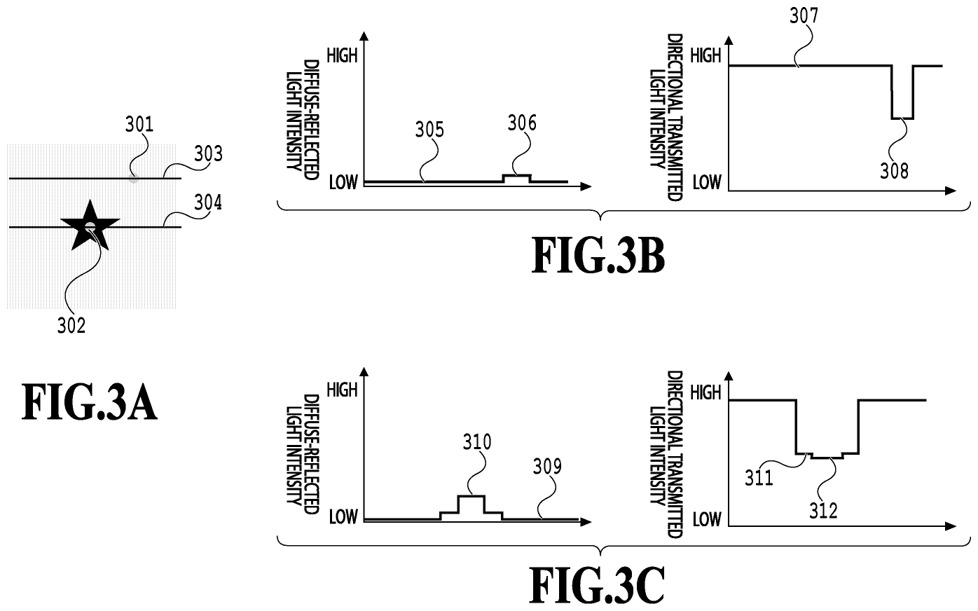

Next, light receiving characteristics of light receiving elements for the diffuse-reflected light intensity 104 and the directional transmitted light intensity 205 in the transparent sheet focused in the present embodiment are explained by using FIGS. 3A to 3C. FIG. 3A is a schematic diagram illustrating a defect 301 that is formed by erroneous attaching of a color material and a portion around which is a transparent portion of a printed material, and a defect 302 formed by erroneous application of a color material with a higher reflectance than a surrounding printing portion.

A left diagram of FIG. 3B schematically illustrates a profile of a diffuse-reflected light intensity along a first line 303, and illustrates a diffuse-reflected light intensity 305 of a portion that includes only the transparent sheet and to which no color material is attached and a diffuse-reflected light intensity 306 of a defect 301 portion to which the color material is attached. A right diagram of FIG. 3B schematically illustrates a profile of a directional transmitted light intensity along the first line 303, and illustrates a directional transmitted light intensity 307 of the portion that includes only the transparent sheet and to which no color material is attached and a directional transmitted light intensity 308 of the defect 301 portion to which the color material is attached.

A left diagram of FIG. 3C schematically illustrates a profile of a diffuse-reflected light intensity along a second line 304. The left diagram of FIG. 3C illustrates a diffuse-reflected light intensity 309 of a normal printed portion and a diffuse-reflected light intensity 310 of a defect 302 portion to which the color material with higher reflectance than the normal printed portion therearound is applied. A right diagram of FIG. 3C schematically illustrates a profile of a directional transmitted light intensity along the second line 304. The right diagram of FIG. 3C illustrates a directional transmitted light intensity 311 of the normal printed portion and a directional transmitted light intensity 312 of the defect 302 portion to which the color material with higher reflectance than the normal printed portion therearound is applied.

Although the defect 301 can be easily distinguished on the printed material with the eyes, a difference between the diffuse-reflected light intensities 305 and 306 is small, and detection of the defect 301 based on the profile of the diffuse-reflected light intensity is difficult. Meanwhile, a difference between the directional transmitted light intensities 307 and 308 is large, and detection of the defect 301 based on the profile of the directional transmitted light intensity is easy. Furthermore, regarding the defect 302, a difference between the diffuse-reflected light intensities 309 and 310 is large, and detection of the defect 302 based on the profile of the diffuse-reflected light intensity is easy. Meanwhile, a difference between the directional transmitted light intensities 311 and 312 is small, and detection of the defect 302 based on the profile of the directional transmitted light intensity is difficult.

As described above, in the inspection of the printed material using the transparent sheet based on captured images performed by using the light receiving elements, an illumination method suitable for detection of a defect varies depending on whether a color material is present around the defect. Accordingly, in a technology of the present disclosure, in view of the above characteristics, usage ratios of the diffuse-reflected light intensity and the directional transmitted light intensity is changed for each region of the printed material based on the transparency indicating a transmittance of directional transmitted light, to enable an improvement in detection accuracy of a defect on the printed material using the transparent sheet.

### <Explanation of Entire System>

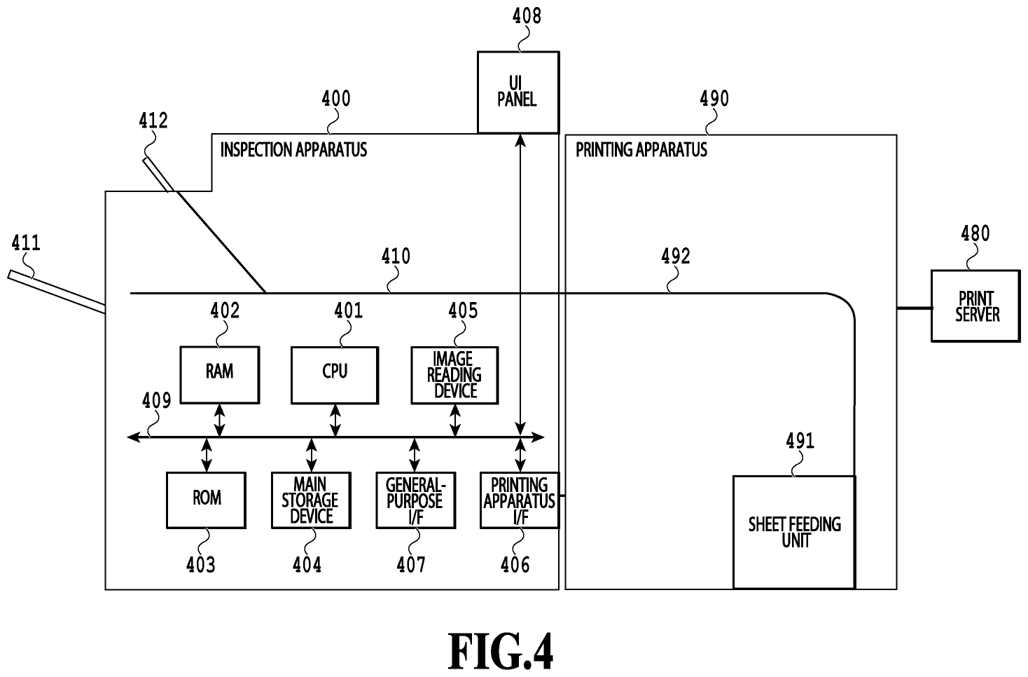

FIG. 4 is a configuration example of an entire printing system that performs output and inspection of a printed material and that includes an inspection apparatus 400 to which the present invention is applied. The printing system of the present embodiment includes the inspection apparatus 400, a print server 480, and a printing apparatus 490. The print server 480 generates a print job of an original document to be printed, and inputs the print job into the printing apparatus 490. The printing apparatus 490 forms an image on a sheet based on the print job received from the print server 480. The printing apparatus 490 includes a sheet feeding unit 491, and a user sets print sheets in the sheet feeding unit in advance. In the case where the printing apparatus 490 receives the print job, the printing apparatus 490 conveys the print sheet set in the sheet feeding unit 491 along a conveyance route 492 while forming images on a front surface or both surfaces of the conveyed print sheet, and sends the print sheet to the inspection apparatus 400.

The inspection apparatus 400 to which the present invention is applied obtains a printed material formed by causing the printing apparatus 490 to form images on the sheet, from the conveyance route 492, and performs inspection processing in which presence or absence of a defect is checked by reading the printed material and performing image processing on read images. The inspection apparatus 400 internally includes a CPU 401, a RAM 402, a ROM 403, a main storage device 404, an image reading device 405, an interface 406 with the printing apparatus, a general-purpose interface 407, a user interface panel 408, and a main bus 409. Moreover, the inspection apparatus 400 includes a conveyance route 410 of the printed material connected to the conveyance route 492 of the printing apparatus 490, an output tray 411 for printed finished products having passed the inspection, and an output tray 412 for printed materials in which a defect is found and that have failed the inspection.

The CPU 401 is a processor that integrally controls the units in the inspection apparatus 400 and performs image processing and the like on image data. The RAM 402 functions as a main memory, a work memory, and the like of the CPU 401. The ROM 403 stores a boot program for activating the inspection apparatus 400 that is executed by the CPU 401 and the like. The main storage device 404 stores an application program executed by the CPU 401, data used in the image processing, and the like. The image reading device (scanner) 405 can read one surface or both surfaces of the printed material sent from the printing apparatus 490 on the conveyance route 410, and obtain read information as the image data. The printing apparatus interface 406 is connected to the printing apparatus 490, and can achieve synchronization of a processing timing of the printed material with the printing apparatus 490 and communicate with the printing apparatus 490 about operation statuses of both apparatuses. The general-purpose interface 407 is a serial bus interface such as USB or IEEE 1394, and the user can obtain data such as a log. The user interface panel 408 is, for example, a liquid crystal display, functions as a user interface of the inspection apparatus 400, can present a current status and setting to the user by displaying them, and includes a touch panel or a button to receive an instruction from the user. The main bus 409 connects the portions of the inspection apparatus 400 to one another.

Moreover, internal portions of the inspection apparatus 400 and the print system can be operated by instructions from the CPU 401. For example, the CPU 401 can move the conveyance routes in synchronization, or switch a tray to which the printed material is to be sent between the output tray 411 for passed and the output tray 412 for failed depending on the inspection result.

As a whole, the inspection apparatus 400 conveys the printed material sent from the printing apparatus 490 in the conveyance route 410 while performing the inspection processing to be explained below based on the image data of the printed material read by the image reading device 405. The printed material is conveyed to the output tray 411 for passed if the printed material passes the inspection, and is conveyed to the output tray 412 for failed if not. Only the printed materials whose quality is checked to be at a predetermined level can be thereby collected in the output tray 411 for delivery.

### <Explanation of Block Diagram of Image Processing Unit>

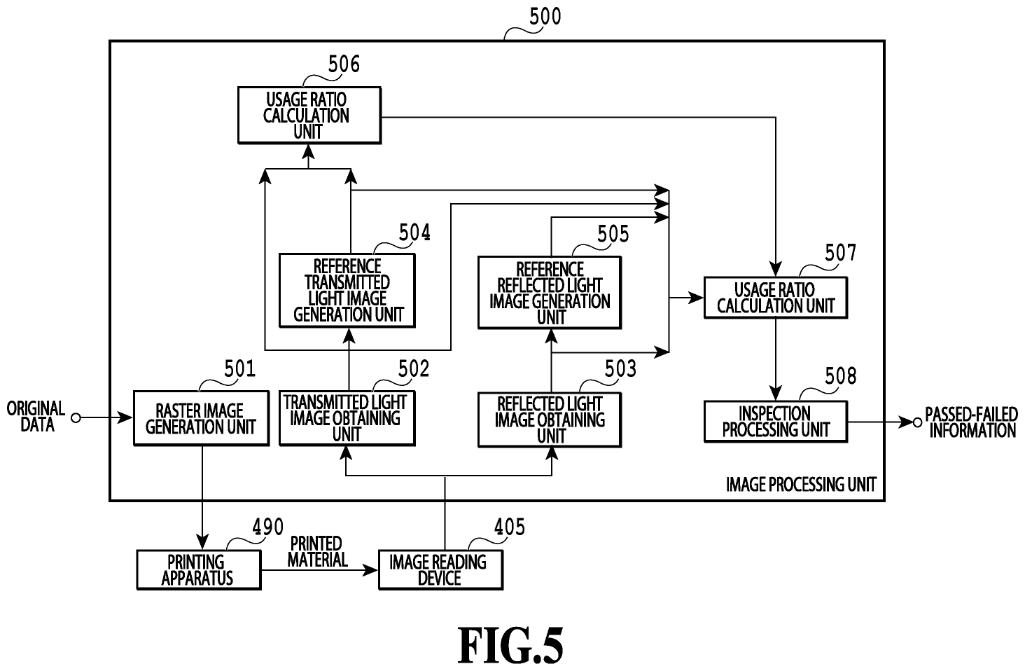

FIG. 5 illustrates a system configuration of an image processing unit 500 relating to the inspection processing of the present embodiment. The image processing unit 500 includes a raster image generation unit 501, a transmitted light image obtaining unit 502, a reflected light image obtaining unit 503, a reference transmitted light image generation unit 504, a reference reflected light image generation unit 505, a usage ratio calculation unit 506, a weighting unit 507, and an inspection processing unit 508. As an input of the image processing unit 500 in the present embodiment, the image processing unit 500 receives a control signal transmitted to the image processing unit 500 as necessary or in synchronization with output of the printed material from the printing apparatus 490. Output of the image processing unit 500 is passed-failed information of the inspection processing based on images obtained in the transmitted light image obtaining unit 502 and the reflected light image obtaining unit 503, and is used as a control signal for an internal operation of the printing system.

The raster image generation unit 501 obtains PDL data that is original document data, and generates a raster image RIP (x, y) generated by performing raster image processor (RIP) processing on the PDL data. In the printing apparatus 490, a control signal for forming the raster image RIP (x, y) on the sheet is created, and printing is performed. In this case, x expresses any position in a horizontal direction of two-dimensional data, y expresses any position in a vertical direction of the two-dimensional data, and (x, y) expresses a value of the position specified by x and y. Hereinafter, description of (x, y) is omitted for sake of convenience.

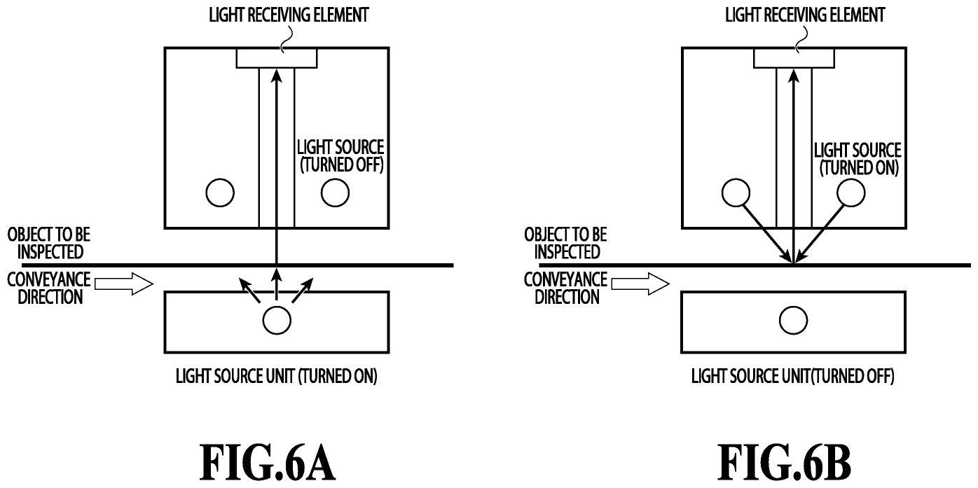

The transmitted light image obtaining unit 502 obtains the printed material printed in the printing apparatus 490, obtains directional transmitted light intensity distribution by irradiating the printed material with an illumination and detecting directional transmitted light from the printed material, and generates a directional transmitted light intensity image Tr. FIG. 6A illustrates an illumination method in reading of the directional transmitted light intensity image Tr in the image reading device 405. In the reading of the directional transmitted light intensity image Tr, the image reading device 405 turns on an illumination arranged on the opposite side of the printed material to the light receiving element. Note that, in the present disclosure, an image that is an inspection target among the directional transmitted light intensity images Tr is referred to as inspection transmitted light image TrT.

The reflected light image obtaining unit 503 obtains the printed material printed in the printing apparatus 490, obtains diffuse-reflected light intensity distribution by irradiating the printed material with an illumination and detecting diffused reflected light from the printed material, and generates a diffuse-reflected light intensity image Dr. FIG. 6B illustrates an illumination method in reading of the diffuse-reflected light intensity image Dr in the image reading device 405. In the reading of the diffuse-reflected light intensity image Dr, the image reading device 405 turns on an illumination arranged on the same side of the printed material as the light receiving element. Note that, in the present disclosure, an image that is an inspection target among the diffuse-reflected light intensity images Dr is referred to as inspection reflected light image DrT.

Moreover, in the image reading device 405 illustrated in FIG. 6, the configuration is such that the illuminations are arranged on both sides of the conveyance route of the printed material, and one light receiving element can read both of the directional transmitted light intensity image Tr and the diffuse-reflected light intensity image Dr. However, the present invention is not limited to this configuration. For example, the configuration may be such that the image reading device 405 includes two light receiving elements, and includes a light receiving element and an illumination dedicated to reading of the directional transmitted light intensity image Tr and a light receiving element and an illumination dedicated to reading of the diffuse-reflected light intensity image Dr.

The reference transmitted light image generation unit 504 obtains multiple directional transmitted light intensity images Tr from the transmitted light image obtaining unit 502, and synthesizes these images to generate a reference transmitted light image TrR to be a reference of inspection.

The reference reflected light image generation unit 505 obtains multiple diffuse-reflected light intensity images Dr from the reflected light image obtaining unit 503 and synthesizes these images to generate a reference reflected light image DrR to be a reference of inspection.

Note that images generated in advance and stored in the RAM 402, the main storage device 404, or the like may be read and used as the reference transmitted light image TrR and the reference reflected light image DrR.

The usage ratio calculation unit 506 obtains the reference transmitted light image TrR and an incident light intensity I, and generates a reference reflected light usage ratio map Rmap_Dr and a reference transmitted light usage ratio map Rmap_Tr. Moreover, the usage ratio calculation unit 506 obtains the inspection transmitted light image TrT, and generates an inspection reflected light usage ratio map Tmap_Dr and an inspection transmitted light usage ratio map Tmap_Tr.

The weighting unit 507 obtains the reference reflected light image DrR and the reference reflected light usage ratio map Rmap_Dr, and generates a weighted reference reflected light image DrRW to which the usage ratio map is applied. Moreover, the weighting unit 507 obtains the reference transmitted light image TrR and the reference transmitted light usage ratio map Rmap_Tr, and generates a weighted reference transmitted light image TrRW to which the usage ratio map is applied. Similarly, the weighting unit 507 obtains the inspection reflected light image DrT and the inspection reflected light usage ratio map Tmap_Dr, and generates a weighted inspection reflected light image DrTW to which the usage ratio map is applied. The weighting unit 507 obtains the inspection transmitted light image TrT and the inspection transmitted light usage ratio map Tmap_Tr, and generates a weighted inspection transmitted light image TrTW to which the usage ratio map is applied.

The inspection processing unit 508 obtains the weighted reference reflected light image DrRW, the weighted reference transmitted light image TrRW, the weighted inspection reflected light image DrTW, and the weighted inspection transmitted light image TrTW outputted from the weighting unit 507. Then, the inspection processing unit 508 outputs inspection result information indicating whether the printed material includes a defect or not, based on a difference between the weighted reference reflected light image DrRW and the weighted inspection reflected light image DrTW and a difference between the weighted reference transmitted light image TrRW and the weighted inspection transmitted light image TrTW.

### <Explanation of Flow of Image Processing Unit>

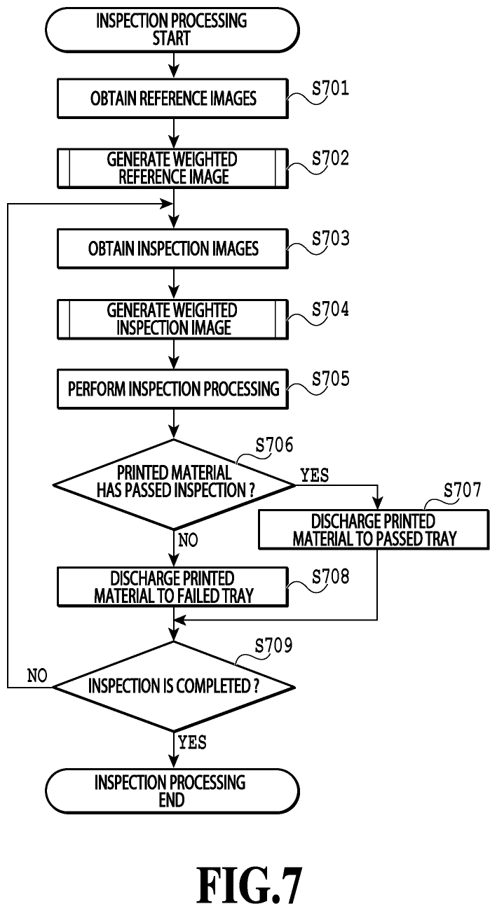

FIG. 7 is a flowchart illustrating inspection processing including the inspection processing executed by the image processing unit 500 in the present embodiment. The CPU 401 reads and executes a program along the flowchart illustrated in FIG. 7.

In S701, the usage ratio calculation unit 506 obtains the reference transmitted light image TrR from the reference transmitted light image generation unit 504. Moreover, the weighting unit 507 obtains the reference transmitted light image TrR and the reference reflected light image DrR from the reference transmitted light image generation unit 504 and the reference reflected light image generation unit 505.

In S702, the usage ratio calculation unit 506 generates the reference reflected light usage ratio map Rmap_Dr and the reference transmitted light usage ratio map Rmap_Tr based on the obtained reference transmitted light image TrR. Moreover, the weighting unit 507 generates the weighted reference reflected light image DrRW obtained by applying the reference reflected light usage ratio map Rmap_Dr to the reference reflected light image DrR. Similarly, the weighting unit 507 generates the weighted reference transmitted light image TrRW obtained by applying the reference transmitted light usage ratio map Rmap_Tr to the reference transmitted light image TrR. A detailed flow is explained later. Conventional color conversion, fine line correction, local distortion correction processing, or the like may be combined with the weighting processing.

In S703, the usage ratio calculation unit 506 obtains the inspection transmitted light image TrT from the transmitted light image obtaining unit 502. Moreover, the weighting unit 507 obtains the inspection transmitted light image TrT and the inspection reflected light image DrT from the transmitted light image obtaining unit 502 and the reflected light image obtaining unit 503.

In S704, the usage ratio calculation unit 506 generates the inspection reflected light usage ratio map Tmap_Dr and the inspection transmitted light usage ratio map Tmap_Tr based on the obtained inspection transmitted light image TrT. Moreover, the weighting unit 507 generates the weighted inspection reflected light image DrTW obtained by applying the inspection reflected light usage ratio map Tmap_Dr to the inspection reflected light image DrT. Similarly, the weighting unit 507 generates the weighted inspection transmitted light image TrTW obtained by applying the inspection transmitted light usage ratio map Tmap_Tr to the inspection transmitted light image TrT. A detailed flow is explained later. In the present embodiment, conventional color conversion, fine line correction, local distortion correction processing, or the like may be combined with the above processing.

In S705, the inspection processing unit 508 obtains the weighted reference reflected light image DrRW and the weighted reference transmitted light image TrRW generated in S702 and the weighted inspection reflected light image DrTW and the weighted inspection transmitted light image TrTW generated in S704. Moreover, the inspection processing unit 508 generates a reference image R by adding up the weighted reference reflected light image DrRW and the weighted reference transmitted light image TrRW. Similarly, the inspection processing unit 508 generates an inspection image T by adding up the weighted inspection reflected light image DrTW and the weighted inspection transmitted light image TrTW. Then, the inspection processing unit 508 performs the inspection processing of detecting a defect in the printed material that is the inspection target, based on a difference between the reference image R and the inspection image T, and makes notification of the inspection result information indicating presence or absence of a defect in the printed material. In the present embodiment, the inspection processing of detecting a defect is assumed to use a conventional technology.

In S706, in the CPU 401, the inspection processing unit 508 determines whether the printed material that is the inspection target has passed or failed the inspection, based on the inspection result information outputted in S705. In the case where the printed material has passed the inspection, the processing proceeds to S707. In the case where the printed material has failed the inspection, the processing proceeds to S708.

In S707, the CPU 401 conveys the printed material under inspection to the passed tray 411.

In S708, the CPU 401 discharges the printed material under inspection to the failed tray 412.

In S709, in the case where the printed material to be the inspection target is left, the CPU 401 repeatedly executes the processing of S703 to S708. In the case where there is no printed material to be the inspection target, the CPU 401 terminates the inspection processing.

### <Explanation of Flow of S702>

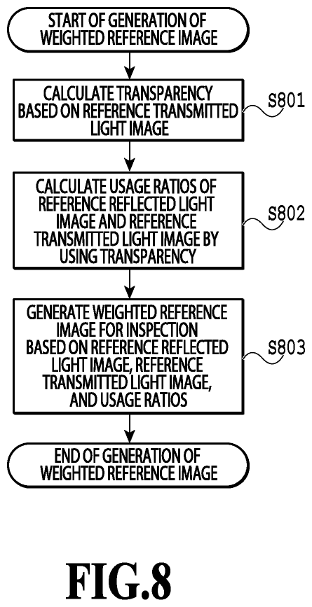

FIG. 8 is a flowchart illustrating details of processing of S702 in the present embodiment. The CPU 401 reads and executes a program along the flowchart illustrated in FIG. 8.

In S801, the usage ratio calculation unit 506 calculates a reference transparency TrR_rate based on the reference transmitted light image TrR. In the present embodiment, the transmitted light image obtaining unit 502 calculates the reference transparency TrR_rate defined by Formula (1) based on the reference transmitted light image TrR and the incident light intensity I of the illumination in the obtaining of the directional transmitted light intensity image Tr.

$$\\ \begin{matrix}TrR\_rate ( x , y ) = \frac{TrR ( x , y )}{I} & Formula ( 1 )\end{matrix}$$

In this case, the incident light intensity I is a value in a range in which the minimum value is 0 and the maximum value is a maximum value that the reference transmitted light image TrR can take, and a value set in advance in the usage ratio calculation unit 506 or a value inputted by the user via the user interface panel 408 may be used. Accordingly, the reference transparency TrR_rate takes a value of 0 or more and 1 or less.

In S802, the usage ratio calculation unit 506 generates the reference reflected light usage ratio map Rmap_Dr and the reference transmitted light usage ratio map Rmap_Tr by using the reference transparency TrR_rate calculated in S801. The reference reflected light usage ratio map Rmap_Dr is calculated by using Formula (2), and the reference transmitted light usage ratio map Rmap_Tr is calculated by using Formula (3).

$$\\ \begin{matrix}Rmap\_Dr ( x , y ) = 1 - ( TrR\_rate ( x , y ) + A ) & Formula ( 2 )\end{matrix}$$

$$\\ \begin{matrix}Rmap\_Tr ( x , y ) = TrR\_rate ( x , y ) & Formula ( 3 )\end{matrix}$$

In this case, A represents a light absorption ratio of the transparent sheet for the incident light intensity I. Note that, in the present embodiment, the reference reflected light usage ratio map Rmap_Dr and the reference transmitted light usage ratio map Rmap_Tr are generated based on the calculation formulae. However, the reference reflected light usage ratio map Rmap_Dr and the reference transmitted light usage ratio map Rmap_Tr are not limited to these. For example, there may be used a look-up table with such a characteristic that the usage ratio of the reference transmitted light image TrR increases in the case where the transparency is high, and the usage ratio of the reference reflected light image DrR increases in the case where the transparency is low.

In S803, the weighting unit 507 generates the reference image R based on the reference reflected light image DrR and the reference transmitted light image TrR, as well as the reference reflected light usage ratio map Rmap_Dr and the reference transmitted light usage ratio map Rmap_Tr calculated in S802. In the present embodiment, as illustrated in Formula (4), the reference image R is a sum of the weighted reference reflected light image DrRW and the weighted reference transmitted light image TrRW.

$$\\ \begin{matrix}R ( x , y ) = Rmap\_Dr ( x , y ) \times DrR ( x , y ) + Rmap\_Tr ( x , y ) \times TrR ( x , y ) & Formula ( 4 )\end{matrix}$$

### <Explanation of Flow of S704>

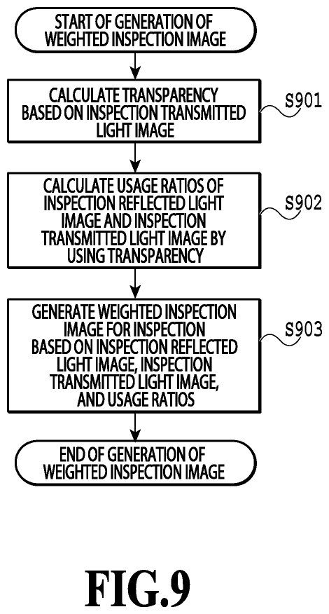

FIG. 9 is a flowchart illustrating details of processing of S704 in the present embodiment. The CPU 401 reads and executes a program along the flowchart illustrated in FIG. 9.

In S901, the usage ratio calculation unit 506 calculates an inspection transparency TrT_rate based on the inspection transmitted light image TrT as in S801. The inspection transparency TrT_rate is defined by replacing the reference transmitted light image TrR in Formula (1) by the inspection transmitted light image TrT.

In S902, the usage ratio calculation unit 506 generates the inspection reflected light usage ratio map Tmap_Dr and the inspection transmitted light usage ratio map Tmap_Tr by using the inspection transparency TrT_rate calculated in S901. The inspection reflected light usage ratio map Tmap_Dr and the inspection transmitted light usage ratio map Tmap_Tr are defined by replacing the reference transparency TrR_rate in each of Formula (2) and Formula (3) by the inspection transparency TrT_rate calculated in S901.

In S903, the weighting unit 507 generates the inspection image T based on the inspection reflected light image DrT, the inspection transmitted light image TrT, the inspection reflected light usage ratio map Tmap_Dr, and the inspection transmitted light usage ratio map Tmap_Tr. In the present embodiment, as illustrated in Formula (5), the inspection image T is a sum of the weighted inspection reflected light image DrTW and the weighted inspection transmitted light image TrTW.

$$\\ \begin{matrix}T ( x , y ) = Tmap\_Dr ( x , y ) \times DrT ( x , y ) + Tmap\_Tr ( x , y ) \times TrT ( x , y ) & Formula ( 5 )\end{matrix}$$

In the above processing, changing the usage ratios of the image obtained based on the diffuse-reflected light and the image obtained based on the directional transmitted light for each region based on the transparency of the printed material enables accurate detection of a defect also in the case where defects occur simultaneously in a transparent portion and a non-transparent portion of the printed material.

### Modified Example 1

In the above-mentioned embodiment, the reference transparency TrR_rate is calculated based on the reference transmitted light image TrR. However, the reference transparency TrR_rate may be calculated based on the raster image RIP used in printing of the printed material that is the inspection target.

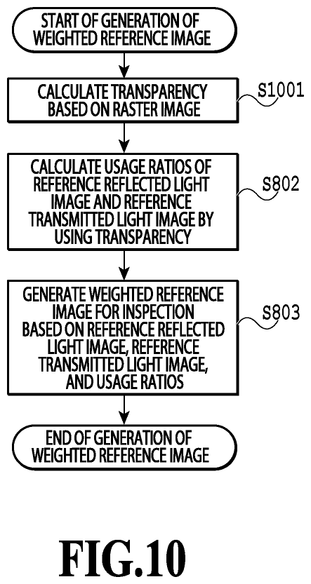

FIG. 10 is a flowchart for calculating the transparency from the raster image RIP that is executed by the image processing unit 500 in the present modified example. The CPU 401 reads and executes a program along the flowchart illustrated in FIG. 10. Since S802 and S803 are the same as those in Embodiment 1, explanation is omitted herein.

In S1001, the raster image RIP used in the printing of the printed material that is the inspection target is obtained, and a reference transparency TrR′ rate is calculated. The reference transparency TrR′_rate is defined by Formula (6).

$$\\ \begin{matrix}{TrR}^{{}_{} ′} \_rate ( x , y ) = \frac{1}{{( RIP ( x , y ) )}^{2}} & Formula ( 6 )\end{matrix}$$

Note that, although the method of calculating the reference transparency TrR′_rate based on the calculation formula is described in the present embodiment, there may be used a look-up table with such a characteristic that the transparency is inversely proportional to a square of the raster image RIP.

The above processing can suppress variations caused by a defect that is highly likely to be reproduced due to a failure or a characteristic of a printer, a defect due to a sheet characteristic, and the like by using the raster image RIP, and enables stable obtaining of highly accurate reference transparency TrR′_rate.

### Modified Example 2

In the embodiment and the modified example described above, the reference transparency TrR_rate and the reference transparency TrR′_rate are calculated based on the reference transmitted light image TrR and the raster image RIP, respectively. Meanwhile, in Modified Example 2, a reference transparency TrR″_rate is calculated based on a size relationship of the reference reflected light image DrR and the reference transmitted light image TrR.

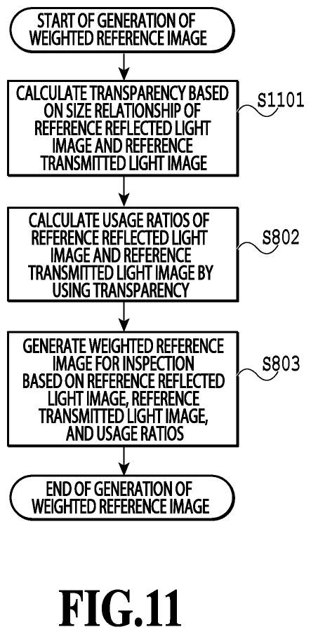

FIG. 11 is a flowchart executed by the inspection apparatus 400 in the present modified example. The CPU 401 reads and executes a program along the flowchart illustrated in FIG. 11. Since S802 and S803 are the same as those in Embodiment 1, explanation is omitted herein.

In S1101, the reference reflected light image DrR and the reference transmitted light image TrR are obtained, and the reference transparency TrR″_rate (x, y) is generated. The reference transparency TrR″_rate (x, y) is calculated by using Formula (7).

$$\\ \begin{matrix}{TrR}^{{}_{} ″} \_rate ( x , y ) = \{ \begin{matrix}0 , & DrR ( x , y ) \geq TrR ( x , y ) \\ 1 , & DrR ( x , y ) < TrR ( x , y )\end{matrix} & Formula ( 7 )\end{matrix}$$

In the above processing, using only the data with higher contribution out of the reference reflected light image DrR and the reference transmitted light image TrR can suppress resources necessary for the processing to minimum.

Note that, in the present modified example, description is given of the method of suppressing the necessary resources by setting the reference transparency TrR″_rate to a binary value based on the size relationship of the reference reflected light image DrR and the reference transmitted light image TrR. However, for example, there may be used a method in which the reference transparency TrR_rate defined by Formula (1) is used in the case where the reference transmitted light image TrR is larger than the reference reflected light image DrR, and the reference transparency is set to 0 in the other cases.

### Modified Example 3

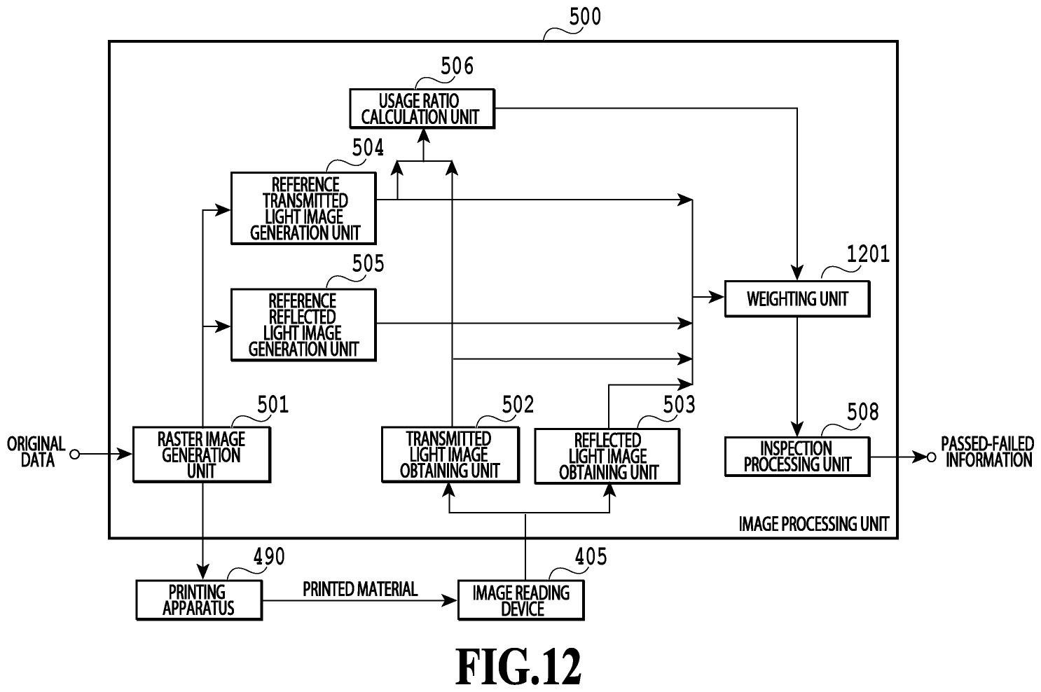

In the embodiment and the modified examples described above, the reference reflected light image DrR and the reference transmitted light image TrR are generated by synthesizing the diffuse-reflected light intensity images Dr and the directional transmitted light intensity images Tr obtained by reading the printed material. Meanwhile, in Modified Example 3, the reference reflected light image DrR and the reference transmitted light image TrR are generated based on the raster image RIP by using a conventional technology. FIG. 12 illustrates a configuration of the image processing unit 500 according to Modified Example 3. Configurations other than the generation method of the reference reflected light image DrR and the reference transmitted light image TrR are the same as those in Embodiment 1.

### Embodiment 2

In Embodiment 1, the weighted reference reflected light image DrRW and the weighted reference transmitted light image TrRW are generated based on the reference reflected light usage ratio map Rmap_Dr and the reference transmitted light usage ratio map Rmap_Tr. Moreover, the weighted inspection reflected light image DrTW and the weighted inspection transmitted light image TrTW are generated based on the inspection reflected light usage ratio map Tmap_Dr and the inspection transmitted light usage ratio map Tmap_Tr. In the present embodiment, the reference reflected light usage ratio map Rmap_Dr and the reference transmitted light usage ratio map Rmap_Tr are used also for the generation of the weighted inspection reflected light image DrTW and the weighted inspection transmitted light image TrTW.

A system configuration and a configuration of the image processing unit 500 that execute a series of processes explained in Embodiment 2 are identical to those in Embodiment 1 except for weighting processing on the inspection transmitted light image TrT and the inspection reflected light image DrT in the weighting unit 507. Accordingly, explanation is omitted except for explanation of the weighting processing on the inspection transmitted light image TrT and the inspection reflected light image DrT in the weighting unit 507. Note that, in Embodiment 2, processing of outputting the inspection transmitted light image TrT from the transmitted light image obtaining unit 502 to the usage ratio calculation unit 506 and processing of generating the inspection reflected light usage ratio map Tmap_Dr and the inspection transmitted light usage ratio map Tmap_Tr by the usage ratio calculation unit 506 are unnecessary.

In the case where the weighting unit 507 generates the weighted reference reflected light image DrRW and the weighted inspection reflected light image DrTW, the weighting unit 507 performs weighting based on the reference reflected light usage ratio map Rmap_Dr. Moreover, in the case where the weighting unit 507 generates the weighted reference transmitted light image TrRW and the weighted inspection transmitted light image TrTW, the weighting unit 507 performs weighting based on the reference transmitted light usage ratio map Rmap_Tr.

### <Main Flow>

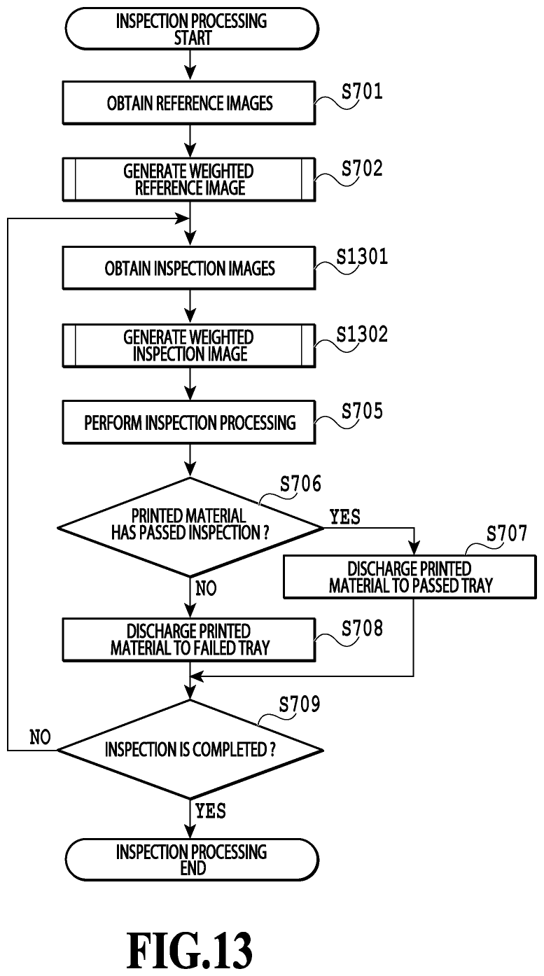

FIG. 13 is a flowchart illustrating inspection processing including inspection processing executed by the image processing unit 500 in the present embodiment. The CPU 401 reads and executes a program along the flowchart illustrated in FIG. 13. Note that, since S701 and S703 to S707 are identical to those in Embodiment 1, explanation is omitted.

In S1301, the weighting unit 507 obtains the inspection transmitted light image TrT and the inspection reflected light image DrT from the transmitted light image obtaining unit 502 and the reflected light image obtaining unit 503.

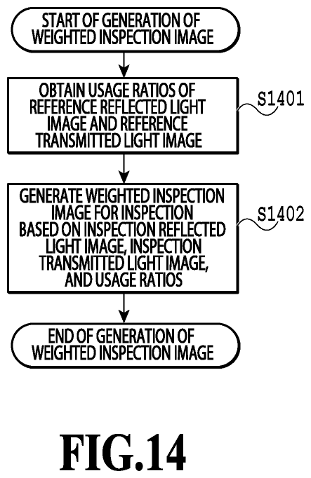

In S1302, the weighting unit 507 obtains the inspection reflected light image DrT, the inspection transmitted light image TrT, the reference reflected light usage ratio map Rmap_Dr, and the reference transmitted light usage ratio map Rmap_Tr, and generates the inspection image T for inspection. FIG. 14 is a flowchart illustrating details of S1302 in the present embodiment. The CPU 401 reads and executes a program along the flowchart illustrated in FIG. 14.

In S1401, the weighting unit 507 obtains the reference reflected light usage ratio map Rmap_Dr and the reference transmitted light usage ratio map Rmap_Tr generated in S802.

In S1402, as illustrated in Formula (8), the weighting unit 507 assigns a weight to the inspection reflected light image DrT by using the reference reflected light usage ratio map Rmap_Dr, assigns a weight to the inspection transmitted light image TrT by using the reference transmitted light usage ratio map Rmap_Tr, and sets a sum of these weighted images as the inspection image T.

$$\\ \begin{matrix}T ( x , y ) = Rmap\_Dr ( x , y ) \times DrT ( x , y ) + Rmap\_Tr ( x , y ) \times TrT ( x , y ) . & Formula ( 8 )\end{matrix}$$

As described above, in the present embodiment, using only the reference reflected light usage ratio map Rmap_Dr and the reference transmitted light usage ratio map Rmap_Tr as the usage ratio maps can reduce processing cost.

### Embodiment 3

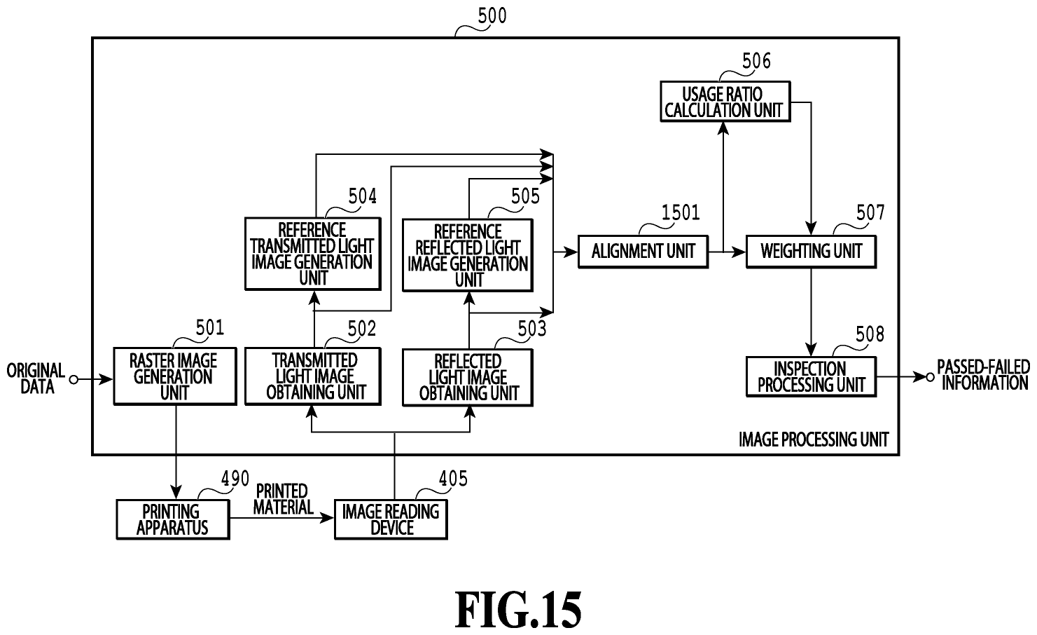

In Embodiment 1, the positional shift among the reference reflected light image DrR, the reference transmitted light image TrR, the inspection reflected light image DrT, and the inspection transmitted light image TrT is not taken into consideration. In the present embodiment, alignment of the reference reflected light image DrR, the reference transmitted light image TrR, the inspection reflected light image DrT, and the inspection transmitted light image TrT is performed, and then the inspection processing is performed. Note that, since a system configuration and a configuration of the image processing unit 500 that execute a series of processes explained in Embodiment 3 are identical to those in Embodiment 1 except for an alignment unit 1501 as illustrated in FIG. 15, explanation of configurations other than the alignment unit 1501 is omitted.

### <Explanation of Block Diagram of Image Processing Apparatus in Embodiment 3>

FIG. 15 illustrates the system configuration of the image processing unit 500 relating to the inspection processing of Embodiment 3. The image processing unit 500 includes the alignment unit 1501 in addition to the configuration of Embodiment 1. Note that, in the present embodiment, explanation is given assuming that an image to be a reference of alignment is the reference reflected light image DrR.

The alignment unit 1501 obtains the reference reflected light image DrR and the reference transmitted light image TrR, performs alignment processing on the reference transmitted light image TrR based on the reference reflected light image DrR, and outputs parameters used for the alignment and an aligned reference transmitted light image TrR_ALI. Moreover, the alignment unit 1501 obtains the inspection reflected light image DrT and the inspection transmitted light image TrT, and performs alignment processing also on the inspection reflected light image DrT and the inspection transmitted light image TrT based on the reference transmitted light image TrR. Then, the alignment unit 1501 outputs an aligned inspection reflected light image DrT_ALI and an aligned inspection transmitted light image TrT_ALI.

### <Main Flow>

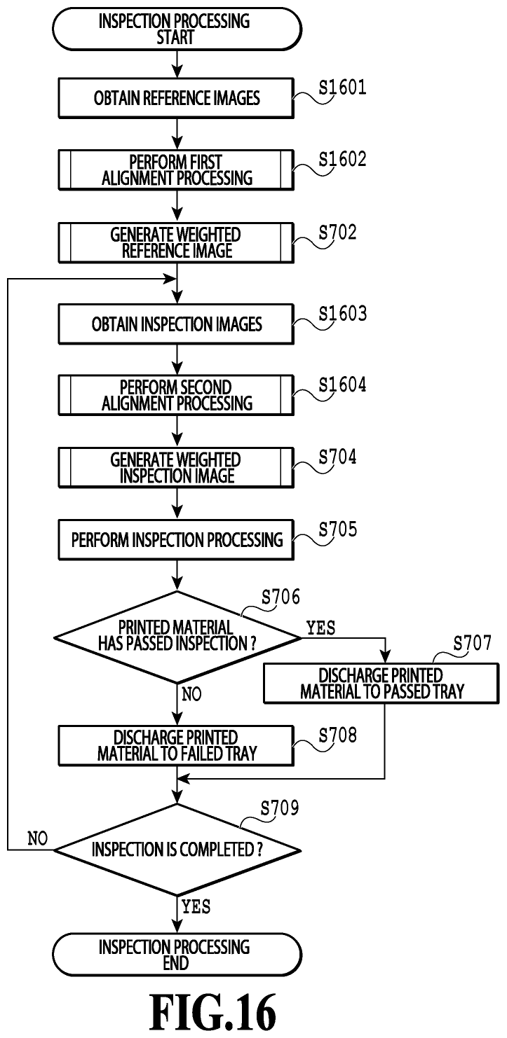

FIG. 16 is a flowchart illustrating inspection processing including inspection processing executed by the image processing unit 500 in Embodiment 3. The CPU 401 reads and executes a program along the flowchart illustrated in FIG. 16. Note that, since S702 and S704 to S709 are identical to those in Embodiment 1, explanation is omitted.

In S1601, the alignment unit 1501 obtains the reference transmitted light image TrR and the reference reflected light image DrR from the reference transmitted light image generation unit 504 and the reference reflected light image generation unit 505.

In S1602, the alignment unit 1501 executes first alignment processing on the reference transmitted light image TrR based on the obtained reference reflected light image DrR, and updates the reference transmitted light image TrR to the aligned reference transmitted light image TrR_ALI. The alignment unit 1501 outputs a first parameter used for the alignment. Although a detailed flow is described later, the alignment processing uses a conventional technology.

In S1603, the alignment unit 1501 obtains the inspection reflected light image DrT and the inspection transmitted light image TrT.

In S1604, the alignment unit 1501 executes second alignment processing on the inspection reflected light image DrT based on the obtained reference reflected light image DrR, and updates the inspection reflected light image DrT to the aligned inspection reflected light image DrT_ALI. Similarly, the alignment unit 1501 executes the second alignment processing on the inspection transmitted light image TrT based on the aligned reference transmitted light image TrR_ALI, and updates the inspection transmitted light image TrT to the aligned inspection transmitted light image TrT_ALI. Although a detailed flow is described later, the alignment processing uses a conventional technology.

### <Processing Flow of S1602>

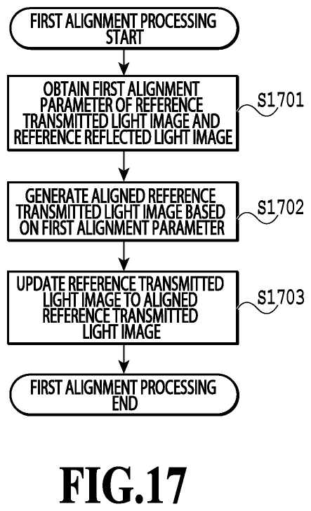

FIG. 17 is a flowchart illustrating details of the processing of S1602 in the present embodiment. The CPU 401 reads and executes a program along the flowchart illustrated in FIG. 17.

In S1701, the alignment unit 1501 obtains the first alignment parameter from the reference reflected light image DrR and the reference transmitted light image TrR. The first alignment parameter is a parameter for correcting the shift between the reference reflected light image DrR and the reference transmitted light image TrR. In a configuration in which the image reading device 405 reads the diffuse-reflected light intensity image Dr and the directional transmitted light intensity image Tr by using separate light receiving elements, a method of calculating the first alignment parameter in advance in calibration is used to correct the shift of the light receiving elements.

In S1702, the alignment unit 1501 executes alignment processing with respect to the reference reflected light image DrR based on the first alignment parameter obtained in S1701, and generates the aligned reference transmitted light image TrR_ALI.

In S1703, the alignment unit 1501 updates the reference transmitted light image TrR to the aligned reference transmitted light image TrR_ALI generated in S1702.

### <Processing Flow of S1604>

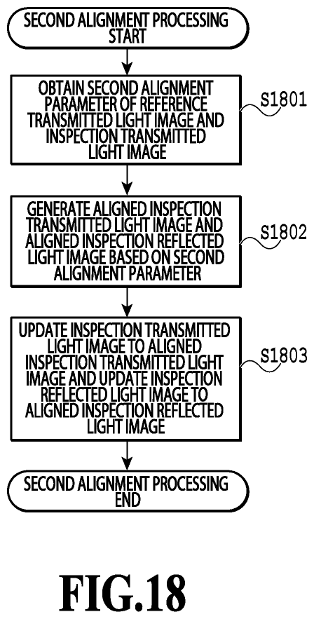

FIG. 18 is a flowchart illustrating details of the processing of S1604 in the present embodiment. The CPU 401 reads and executes a program along the flowchart illustrated in FIG. 18.

In S1801, the alignment unit 1501 obtains a second alignment parameter. The second alignment parameter is a parameter for correcting the shift between the reference image and the inspection image. The second alignment parameter is calculated by using the reference transmitted light image TrR and the inspection transmitted light image TrT.

In S1802, the alignment unit 1501 generates the aligned inspection reflected light image DrT_ALI subjected to the second alignment processing, based on the reference reflected light image DrR, the inspection reflected light image DrT, and the second alignment parameter. Moreover, the alignment unit 1501 generates an aligned inspection transmitted light image TrT_ALI′ subjected to the second alignment processing, based on the reference transmitted light image TrR, the inspection transmitted light image TrT, and the second alignment parameter. Furthermore, the alignment unit 1501 performs the first alignment processing on the aligned inspection transmitted light image TrT_ALI′ subjected to the second alignment processing, and outputs the aligned inspection transmitted light image TrT_ALI.

In S1803, the alignment unit 1501 updates the inspection reflected light image DrT to the aligned inspection reflected light image DrT_ALI generated in S1802, and updates the inspection transmitted light image TrT to the aligned inspection transmitted light image TrT_ALI.

In Embodiment 3, the above processing enables maintaining of high inspection accuracy also in the case where the positional shift occurs among the reference reflected light image DrR, the reference transmitted light image TrR, the inspection reflected light image DrT, and the inspection transmitted light image TrT.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present invention, a defect in the printed material using the transparent sheet can be detected with high accuracy.

What is claimed is:

1. An image processing apparatus comprising:
a first obtaining unit configured to obtain a first inspection target image obtained by receiving reflected light from a printed material and a second inspection target image obtained by receiving transmitted light from the printed material;
a second obtaining unit configured to obtain a first reference image corresponding to the first inspection target image and a second reference image corresponding to the second inspection target image; and
an inspection unit configured to perform at least one of first inspection using the first reference image and the first inspection target image and second inspection using the second reference image and the second inspection target image for each of regions in the printed material.

2. The image processing apparatus according to claim 1, wherein the inspection unit performs at least one of the first inspection and the second inspection based on a transparency of each of the regions in the printed material.

3. The image processing apparatus according to claim 1, wherein the inspection unit performs the first inspection for a region in which a transparency is low, and performs the second inspection for a region in which the transparency is high.

4. The image processing apparatus according to claim 1, further comprising a derivation unit configured to derive usage ratio distribution of the reflected light and the transmitted light based on a transparency in each of the regions of the printed material,
wherein the inspection unit assigns weights to a result of the first inspection and a result of the second inspection based on the usage ratio distribution.

5. The image processing apparatus according to claim 4, wherein the derivation unit calculates the transparency based on a ratio between a pixel value of the second reference image and an intensity of light emitted in reading of the printed material.

6. The image processing apparatus according to claim 4, wherein the derivation unit calculates, as the transparency, a first transparency based on a ratio between a pixel value of the second reference image and an intensity of light emitted in reading of the printed material and a second transparency based on a ratio between a pixel value of the second inspection target image and the intensity of light emitted in reading of the printed material, derives usage ratio distribution for weighting of the first and second reference images based on the first transparency, and derives usage ratio distribution for weighting of the first and second inspection target images based on the second transparency.

7. The image processing apparatus according to claim 4, wherein the derivation unit determines a usage ratio of the transmitted light in the usage ratio distribution based on the transparency.

8. The image processing apparatus according to claim 4, wherein the derivation unit determines a usage ratio of the reflected light in the usage ratio distribution based on the transparency and a light absorption ratio of a transparent sheet.

9. The image processing apparatus according to claim 8, wherein a usage ratio of the transmitted light and the usage ratio of reflected light are determined such that a sum of the usage ratio of the transmitted light and the usage ratio of the reflected light is constant.

10. The image processing apparatus according to claim 1, wherein the inspection unit performs alignment processing on the first and second reference images and the first and second inspection target images.

11. The image processing apparatus according to claim 1, wherein the first reference image and the second reference image are images generated by synthesizing a plurality of images obtained by reading the printed material.

12. The image processing apparatus according to claim 1, wherein the first reference image and the second reference image are images generated based on print data for printing the printed material.

13. An image processing method comprising:
obtaining a first inspection target image obtained by receiving reflected light from a printed material and a second inspection target image obtained by receiving transmitted light from the printed material;
obtaining a first reference image corresponding to the first inspection target image and a second reference image corresponding to the second inspection target image; and
performing at least one of first inspection using the first reference image and the first inspection target image and second inspection using the second reference image and the second inspection target image for each of regions in the printed material.

14. A non-transitory computer readable storage medium storing a program that causes a computer to execute an image processing method comprising:
obtaining a first inspection target image obtained by receiving reflected light from a printed material and a second inspection target image obtained by receiving transmitted light from the printed material;
obtaining a first reference image corresponding to the first inspection target image and a second reference image corresponding to the second inspection target image; and
performing at least one of first inspection using the first reference image and the first inspection target image and second inspection using the second reference image and the second inspection target image for each of regions in the printed material.
